(19) United States
(12) Patent Application Publication
(10) Pub. No.: US 2017/0293335 A1
(43) Pub. Date: Oct. 12, 2017

(54) ADJUSTABLE POWER DELIVERY APPARATUS FOR UNIVERSAL SERIAL BUS (USB) TYPE-C

(71) Applicants: Robert A. Dunstan, Forest Grove, OR (US); Don J. Nguyen, Portland, OR (US); Chee Lim Nge, Hillsboro, OR (US); James M. Yoder, Beaverton, OR (US)

(72) Inventors: Robert A. Dunstan, Forest Grove, OR (US); Don J. Nguyen, Portland, OR (US); Chee Lim Nge, Hillsboro, OR (US); James M. Yoder, Beaverton, OR (US)

(21) Appl. No.: 15/169,175

(22) Filed: May 31, 2016

Related U.S. Application Data
(60) Provisional application No. 62/320,319, filed on Apr. 8, 2016.

(51) Int. Cl. G06F 1/26; G06F 13/40; H02M 1/08; G06F 13/42; H02J 7/00; H02J 7/02

(52) U.S. Cl. CPC G06F 1/266; H02J 7/0042; H02J 7/0052; H02J 7/025; H02M 1/08; G06F 13/4282; G06F 13/4022; H02J 2007/0062

(57) ABSTRACT

A Power Provider is described which comprises a pull-up resistive device to pull-up a sideband unit (SBU) pin; and logic to adjust voltage level on a power supply node (VBUS) according to the voltage and/or current condition on the SBU pin. A Power Consumer is described which comprises: logic to modulate voltage and/or current on SBU pin; and logic to receive a power supply on a power supply node (VBUS) according to the modulated voltage and/or current on the SBU pin. A USB system is described which comprises: a power provider having a first SBU pin which is pulled high; a power consumer having a second SBU pin, wherein the power consumer is operable to modulate voltage/current on the second SBU pin; and a USB Type-C cable coupled to the power provider and the power consumer such that the first and second SBU pins are electrically connected.

### CLAIM FOR PRIORITY

This application claims priority to U.S. Provisional Patent Application Ser. No. 62/320,319 filed on 8 Apr. 2016, titled “ADJUSTABLE POWER DELIVERY APPARATUS FOR UNIVERSAL SERIAL BUS (USB) TYPE-C”, and which is incorporated by reference in entirety.

### BACKGROUND

The Universal Serial Bus (USB) Power Delivery (USB-PD) Specification Revision 2.0 V1.2 of Mar. 25, 2016 states that the USB has evolved from a data interface capable of supplying limited power to a primary provider of power with a data interface. Today, many devices charge or get their power from USB ports contained in laptops, cars, aircraft, or even wall sockets. USB has become a ubiquitous power socket for many small devices such as cell phones, MP3 players and other hand-held devices. Users need USB to fulfill their requirements not only in terms of data but also to provide power to, or charge, their devices simply, often without the need to load a driver, in order to carry out “traditional” USB functions.

### BRIEF DESCRIPTION OF THE DRAWINGS

The embodiments of the disclosure will be understood more fully from the detailed description given below and from the accompanying drawings of various embodiments of the disclosure, which, however, should not be taken to limit the disclosure to the specific embodiments, but are for explanation and understanding only.

FIG. 1 illustrates a typical Universal Serial Bus (USB) power delivery system using a variable power source.

FIG. 2 illustrates a flowchart showing the negotiation protocol for the USB power delivery system of FIG. 1.

FIG. 3A illustrates top and bottom views of a USB Type-C Plug Paddle Card which is configured to provide adjustable power supply to a power consumer, according to some embodiments of the disclosure.

FIG. 3B illustrates USB Type-C Receptacle Interface (Front View) which is configured to receive adjustable power supply from a power provider, according to some embodiments of the disclosure.

FIG. 3C illustrates USB Full-Featured Type-C Plug Interface (Front View) which is configured to provide adjustable power supply to a Power Consumer, according to some embodiments of the disclosure.

FIG. 4 illustrates a USB power delivery system using an adjustable power source, in accordance with some embodiments of the disclosure.

FIG. 5 illustrates a flowchart of a method to provide adjusted power supply, in accordance with some embodiments of the disclosure.

FIG. 6 illustrates a flowchart of a method to request power supply, in accordance with some embodiments of the disclosure.

FIG. 7 illustrates a USB powered device with a machine readable storage media having instructions that when executed cause a machine (e.g., processor) to perform an operation for requesting adjustment in power supply.

FIG. 8 illustrates an adjustable USB power source with a machine readable storage media having instructions that when executed cause a machine (e.g., processor) to perform an operation for providing an adjusted power supply upon request.

FIG. 9 illustrates a USB power delivery system using an adjustable power source in a wireless charging environment, in accordance with some embodiments of the disclosure.

FIG. 10 illustrates a USB compliant smart device (e.g., Provider, Consumer, or Charging Mat) or a computer system or a SoC (System-on-Chip) having logic to dynamically request and receive adjustable power supply from a USB power source, or logic to dynamically receive a request for new power supply and to dynamically provide the new power supply, according to some embodiments.

### DETAILED DESCRIPTION

Industry is trending towards smaller, lighter and thinner systems. The USB Type-C connector as described by the USB Type-C Specification (e.g., Revision 1.2 released Mar. 25, 2016) defines a small reversible-plug connector USB devices which is designed to accommodate this trend by delivering both power and data in a small thin connector. The USB Type-C Cable and Connector Specification defines a new receptacle, plug, cable, and detection mechanisms that are compatible with existing USB interface electrical and functional specifications.

However, these smaller, lighter and thinner systems have a limited thermal capacity and their battery charging electronics are significant contributor to those thermals. Conventional battery chargers, e.g., battery chargers used in laptop computers and cell phones, can result in 10% to 15% of dissipated power, e.g., for a 30 Watt (W) system, 3.0 W to 4.5 W can be dissipated in the battery charger, which may cause a significant thermal problem for system design, and may limit system performance. Currently, a battery charger may also occupy a significant printed circuit board area, e.g., 300 mm² to 400 mm² for a 30 W system.

Improvements in power efficiency of some battery charger systems may result in reduction of power lost due to heat dissipation. Hence, a battery charger system with efficiency improvements can take advantage of an improved/reduced thermal constraint to receive power at a higher rate than with a conventional battery charger system.

Today, the power adapters used to power these systems offer a fixed output voltage. If the power adapter's output voltage could be tailored to supply exactly what the system needed at any point in time, the thermals generated by its charger electronics could be minimized. The USB PD Specification allows the output voltage and current to be negotiated between the system and the power adapter. The USB-PD Specification defines three types of power sources: Fixed Supply, Battery Supply, and Variable Supply (non-battery). See, for example, Table 6-4 Power Data Object of the Universal Serial Bus (USB) Power Delivery (USB-PD) Specification Revision 2.0 V1.2 of Mar. 25, 2016, which in part is reproduced below:

TABLE 6-4
Power Data Object

| | |
|---|---|
| Bit(s) | Description |

| B31 . . . 30 | Value | Parameter |
|---|---|---|
| | 00b | Fixed supply (Vmin = Vmax) |
| | 01b | Battery |
| | 10b | Variable Supply (non-battery) |
| | 11b | Reserved |

Here, Fixed Supply is used to expose well-regulated fixed voltage power supplies (e.g., 5 V regulated supply). Battery Supply is used to expose a battery that can be connected directly as a Source to VBUS. VBUS is an interconnect or bus voltage pin that carries the power supply. Variable Supply is currently defined to be for “poorly regulated Sources” and specifies a minimum and maximum voltage range, and maximum current.

The USB-PD Specification, however, does not define a “well regulated Variable source” or even a “digitally controlled well regulated Variable source.” Nor does the USB-PD Specification define how a Power Consumer (e.g., a phone to be charged via a USB cable) would request to a Variable power source (i.e., Power Provider) for a specific voltage and/or current within a supported range. As such, the Variable type of power source is unable to tune power input to closely match the efficiency characteristics of a Consumer's voltage regulator (VR). The Variable type of power source is also unable to tune power input to meet the real-time power demands of an electronic circuit.

While USB PD Specification allows the output voltage and current to be negotiated between the system and the power adapter, the time required is in the many tens of milliseconds which is way too slow.

Various embodiments specify changes to the USB Type-C “Power Provider” and “Power Consumer” to be able to control output power on VBUS (as defined by the USB 3.1 Specification) from the Power Provider quickly enough to minimize (or reduce) the thermals generated by its charger electronics. Various embodiments provide the means for the USB system to adapt the power adapter's output to an optimum voltage based on the system's current load—both to charge its battery as well as to supply the rest of the its electronics.

Here, the term “Power Provider” or “Provider,” as defined in the USB-PD Specification, is a capability of a PD (Power Delivery) Port (typically a Host, Hub, or Wall Wart Downstream facing port (DFP)) to source power over the power conductor (e.g., VBUS pin). This corresponds to a Type-C Port with resistor Rp (not shown) asserted on its Configuration Channel (CC) Wire. Configuration Channel (CC) is used in the discovery, configuration and management of connections across a USB Type-C cable.

Here the term “Power Consumer” or “Consumer,” as defined in the USB-PD Specification, is the capability of a PD Port (typically a Device's Upstream Facing Port (UFP)) to sink power from the power conductor (e.g., VBUS pin). This corresponds to a Type-C Port with resistor Rd (not shown) asserted on its CC Wire.

Some embodiments describe an apparatus and method for enabling dynamic adjustment of power supply in a USB environment. There are many technical effects of the various embodiments. For example, some embodiments allow the design of more power-efficient circuitry using a scheme which is transparent to the existing USB Type-C eco-system including hosts, devices, and power adapters. For instance, when an old USB Type-C compliant host (e.g., Power Consumer) is connected to the new power adapter (or Power Provider) described in the various embodiments, the Power Provider or power adaptor works using the traditional protocol (e.g., the old USB Type-C compliant host does not command the new Power Provider to change its output on VBUS, and as such the new Power Provider works with the old USB Type-C compliant host).

Similarly when a new host (e.g., Power Consumer) of some embodiments is connected to an old power adapter (e.g., traditional USB Type-C compliant Power Consumer), the system recognizes the old power adaptor and just works (but it does not get the thermal benefits it would when connected to a new power adapter). For example, the new host determines that there is no pull-up voltage on the SBU (sideband unit) pin and therefore concludes that it is connected to a traditional USB Type-C compliant Power Consumer. Various embodiments allow for adjusting the external power source so that it supplies the optimum power needed by a system's power circuits to minimize the thermals generated inside the system by those circuits. As such, the “recovered” thermals can be used for features like Turbo mode (e.g., a high frequency and voltage mode). Other technical effects will be evident from the various embodiments and figures.

In the following description, numerous details are discussed to provide a more thorough explanation of embodiments of the present disclosure. It will be apparent, however, to one skilled in the art, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct connection, such as electrical, mechanical, or magnetic connection between the things that are connected, without any intermediary devices. The term “coupled” means a direct or indirect connection, such as a direct electrical, mechanical, or magnetic connection between the things that are connected or an indirect connection, through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The term “scaling” generally refers to converting a design (schematic and layout) from one process technology to another process technology and subsequently being reduced in layout area. The term “scaling” generally also refers to downsizing layout and devices within the same technology node. The term “scaling” may also refer to adjusting (e.g., slowing down or speeding up—i.e. scaling down, or scaling up respectively) of a signal frequency relative to another parameter, for example, power supply level. The terms “substantially,” “close,” “approximately,” “near,” and “about,” generally refer to being within +/−10% of a target value.

Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C). The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits and logic blocks described here are metal oxide semiconductor (MOS) transistors or their derivatives, where the MOS transistors include drain, source, gate, and bulk terminals. The transistors and/or the MOS transistor derivatives also include Tri-Gate and FinFET transistors, Gate All Around Cylindrical Transistors, Tunneling FET (TFET), Square Wire, or Rectangular Ribbon Transistors, ferroelectric FET (FeFETs), or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors—BJT PNP/NPN, BiCMOS, CMOS, etc., may be used without departing from the scope of the disclosure.

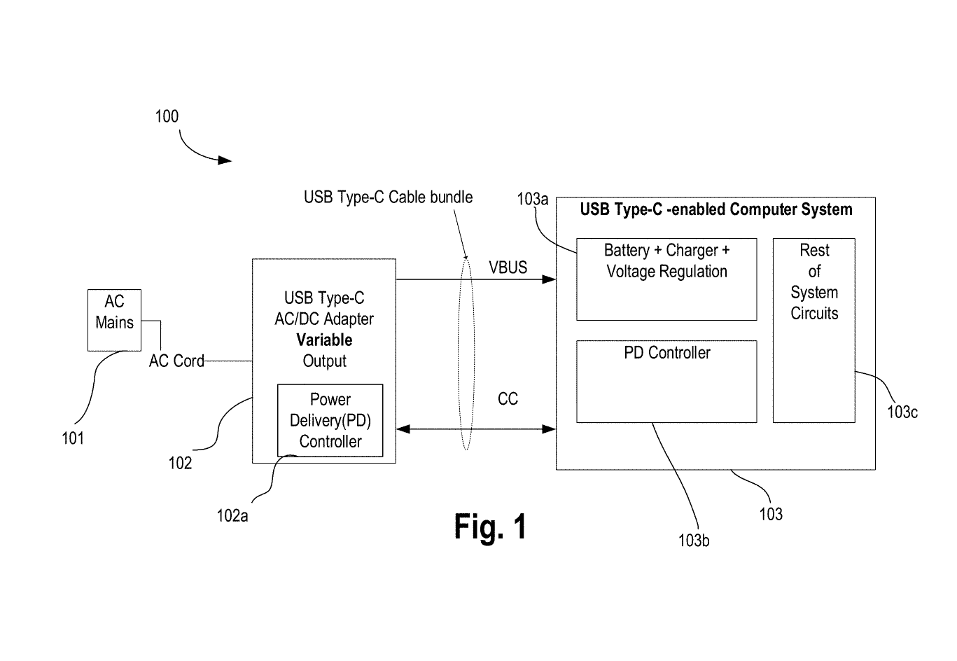

FIG. 1 illustrates a typical USB PD system 100 using a Variable power source. System 100 consists of an Alternating Current (AC) Main receptacle 101 (e.g., a typical wall socket to provide AC voltage and current), a USB Type-C AC/DC (where DC is Direct Current) Adaptor 102 (also referred to as the programmable power supplies) with Variable Output, and USB Type-C enabled computer system 103. System 103 is also referred to as the Power Consumer or Consumer while Adaptor 102 is also referred to as the Power Provider or Provider. Power Provider 102 is coupled to the AC Main 101 via an AC Power Cord. Power Provider 102 communicates with the Power Consumer 103 via VBUS and CC wire(s), which may be part of USB Type-C Cable bundle. A Type-C cable bundle may include VBUS and CC wires and other wires (“not shown”), such as USB2, USB3, SBU1/SBU2, GND, etc. The Power Provider 102 includes a Power Deliver (PD) Controller 102a to control the output voltage on VBUS. PD Controller 103a may be implemented in hardware or software (or a combination of both) and is responsible for communicating with Consumer 103.

Power is provided to Consumer 103 through VBUS wire(s) of the USB Type-C cable. Power negotiation messages (e.g., sending a source capabilities list or menu and a selection from that list) between Consumer 103 and Provider 102 is performed over the CC wire(s) of the USB Type-C cable bundle. The source capabilities include a mandatory vSafe5V (i.e., 5V Fixed Supply) Power Data Object (PDO) and a Variable Output PDO (i.e., Variable Supply (non-battery)).

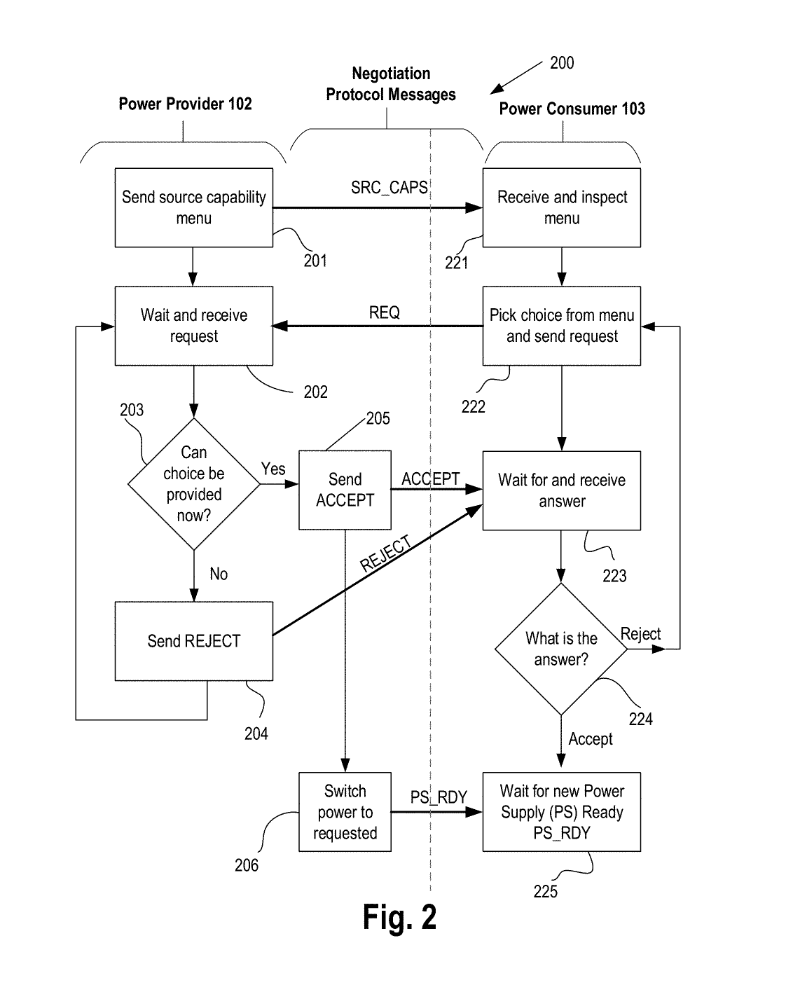

Consumer 103 may be any consumer device (e.g., phone, laptop, printer, etc.) that uses the power supply provided by VBUS to operate. Consumer 103 may include a regulation module or logic 103a such as a battery, charger, and/or voltage regulator (e.g., DC-DC switching regulator). Regulation module or logic 103a is a hardware block that receives power supply from VBUS and uses that power supply to provide regulated power supply to other blocks in Consumer 103. Consumer 103 also includes PD Controller 103b just as Provider 102 includes PD Controller 102a. PD Controller 103b may be implemented in hardware or software (or a combination of both) and is responsible for communicating with Provider 102. The rest of the system circuits (e.g., sensor, memory, phone hardware, etc.) of Consumer 103 are lumped here in module 103c. A typical power delivery process performed by PD Controllers 103b and 103a of Consumer 103 and Provider 102, respectively, is illustrated with reference to FIG. 2.

FIG. 2 illustrates flowchart 200 showing the negotiation protocol for the USB power delivery system of FIG. 1. Flowchart 200 shows operations and negotiations performed by Power Provider 102 and Power Consumer 103 to achieve a desired power supply. Although the blocks in the flowchart with reference to FIG. 2 are shown in a particular order, the order of the actions can be modified. Thus, the illustrated embodiments can be performed in a different order, and some actions/blocks may be performed in parallel. Some of the blocks and/or operations listed in FIG. 2 are optional in accordance with certain embodiments. The numbering of the blocks presented is for the sake of clarity and is not intended to prescribe an order of operations in which the various blocks must occur. Additionally, operations from the various flows may be utilized in a variety of combinations.

At block 201, Provider 102 sends a Source_Capabilities (SRC_CAPS) message as defined by the USB-PD 2.0 Specification to Consumer 103 over wire(s) CC. For example, Provider 102 sends a menu of available power sources (e.g., Power Data Object(s) (PDO) such as fixed, battery, and variable, plus a tuple of a specific voltage and current) to Consumer 103 over wire(s) CC. A PDO is used to expose a Source Port's power capabilities or a Sink's power requirements as part of a Source_Capabilities or Sink_Capabilities message, respectively. Here, a Source is Provider 102 and a Sink is Consumer 103.

At block 221, Consumer 103 receives the menu and inspects PDOs in the menu and selects a favorite choice which can only be one of the PDOs offered by the Provider (i.e., current specification revision does not allow going off menu).

At block 222, Consumer 103 picks a choice from the menu of offered PDOs and sends a Request (REQ) message for its favorite power supply choice to Provider 102. At block 202, Provider 102 waits for and receives the REQ message. The REQ message is defined in Table 6-3 Data Message Types of UBS-PD 2.0 Specification, which is reproduced below:

TABLE 6-3
Data Message Types

| | | | | Valid Start of |
|---|---|---|---|---|
| Bits 3 . . . 0 | Type | Sent by | Description | Packet |
| 0000 | Reserved | | All values not explicitly | |
| | | | defined are Reserved and | |
| | | | shall not be used | |
| 0001 | Source_Capabilities | Source or | See Section 6.4.1.2 | SOP only |
| | | Dual-Role | | |
| 0010 | Request | Sink only | See Section 6.4.2 | SOP only |
| 0011 | BIST | Tester, Source | See Section 6.4.3 | SOP* |
| | | or Sink | | |
| 0100 | Sink_Capabilities | Sink or Dual- | See Section 6.4.1.3 | SOP only |
| | | Role | | |

At block 203, Provider 102 ensures whether it can provide the selected power supply requested at the moment and sends ACCEPT or REJECT message as appropriate. At block 204, if a REJECT message is generated (e.g., Provider 102 is unable to provide the requested supply level), Provider 102 waits for a new Request to service and returns to block 202. At block 205, if an ACCEPT message is generated (e.g., Provider 102 is able to provide the requested power supply), Provider 102 moves to execute block 206. At block 206, Provider 102 switches power to the Requested parameters and sends PS_RDY (Power Supply Ready) indication to Consumer 103.

At the Consumer side, at block 223, Consumer 103 waits for and receives the answer from Provider 102 (e.g., ACCEPT or REJECT message). At block 224, Consumer 103 inspects the answer. If a REJECT message is received by Consumer 103, Consumer 103 goes back to executing process block 222 to pick a next-best choice. If an ACCEPT message is received, then at block 225, Consumer 103 waits for the new power indication from Provider 102 in the form of the PS_RDY (Power Supply Ready) message.

The power source (i.e., Provider 102) is unable to tune power input to closely match the efficiency characteristics of a Consumer's VR. The Variable type of power source is also unable to tune power input to meet the real-time (or dynamic) power demands of an electronic circuit. For example, if a Consumer VR suddenly needs 14 V (fourteen Volts) and Provider 102 can provide either 5 V or 20 V, then when 20 V is provided by Provider 102, Consumer 103 is wasting energy because it is getting more than it needs which translates to low efficiency.

While USB PD Specification allows the output voltage and current to be negotiated between the system and the power adapter, the time required is in the many tens of milliseconds which is way too slow.

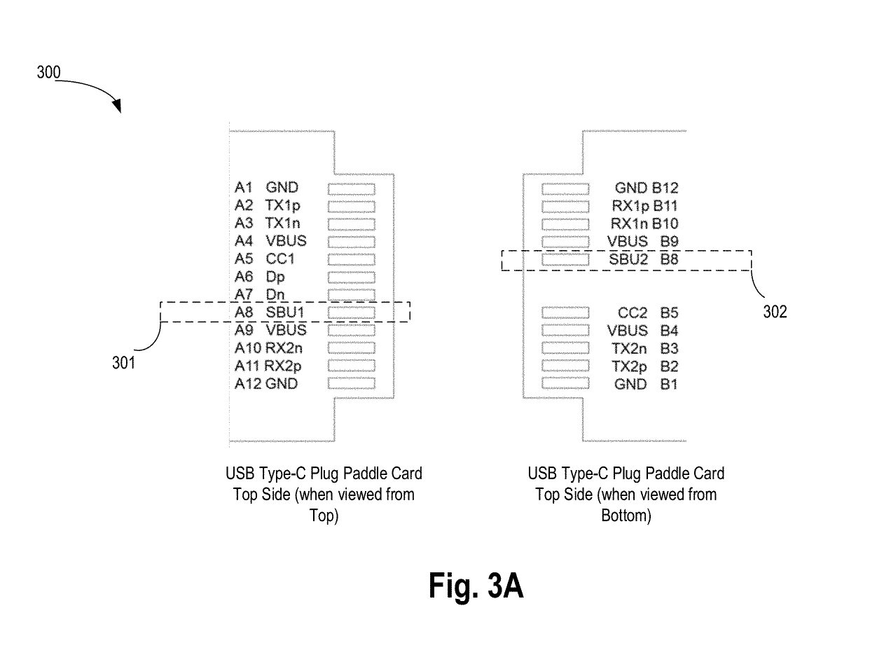

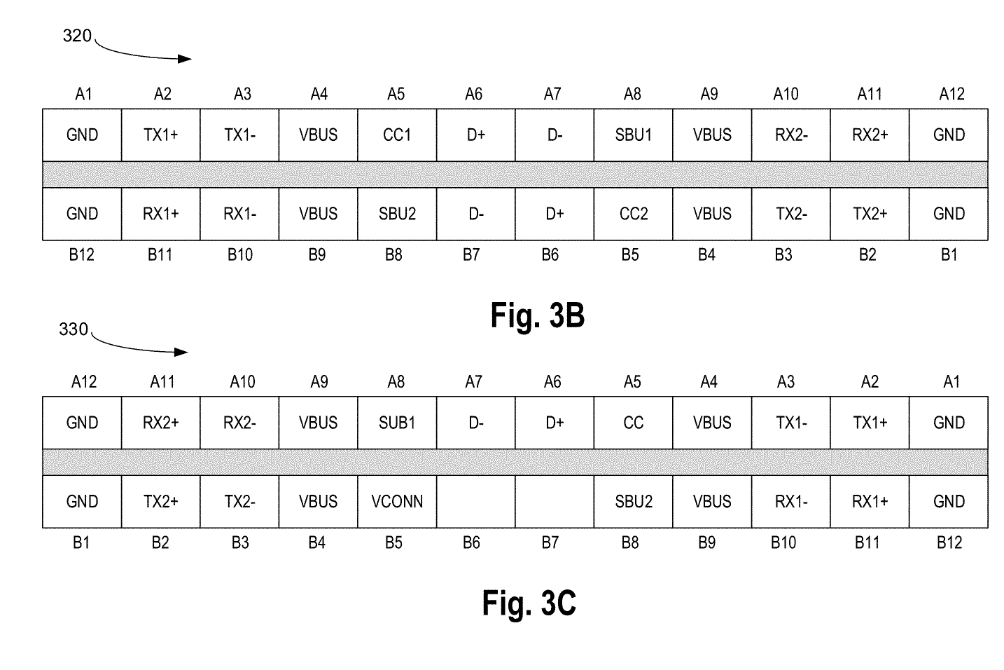

FIG. 3A illustrates top and bottom views 300, respectively, of a USB Type-C Plug Paddle Card which is configured to provide adjustable power supply to a power consumer, according to some embodiments of the disclosure. FIG. 3B illustrates USB Type-C Receptacle Interface (Front View) which is configured to receive adjustable power supply from a Power Provider, according to some embodiments of the disclosure. The signal list functionally delivers both USB 2.0 (D+ and D−) and USB 3.1 (TX and RX pairs) data buses, USB power (VBUS) and ground (GND), Configuration Channel signals (CC1 and CC2), and two Sideband Use (SBU) signal pins (SBU1 301 and SBU2 302). Multiple sets of USB data bus signal locations in this layout facilitate being able to functionally map the USB signals independent of plug orientation in the receptacle. In various embodiments, one or both of the SBU pins (SBU1 301 and SBU2 302) are repurposed to provide quick adjustment to power supply on the VBUS.

FIG. 3C illustrates USB Full-Featured Type-C Plug Interface (Front View) 320 which is configured to provide adjustable power supply to a Power Consumer. For the plug, one CC pin is connected through the cable to establish signal orientation and the other CC pin is repurposed as VCONN for powering electronics in the USB Type-C plug. Generally, VCONN wire is used to power active or electronically marked cables. Also, one set of USB 2.0 D+/D− wires is implemented in a USB Type-C cable. In traditional USB Type-C cables that merely intend to support USB 2.0 functionality, the USB 3.1 and SBU signals are not implemented. In various embodiments, one or both of the SBU pins are repurposed to provide quick adjustment to power supply on VBUS. While various embodiments describe repurposing one or more SBU pins, other pins may be repurposed to accomplished the same task. For example in an alternate mode, the unused D+/D− pins may be substituted.

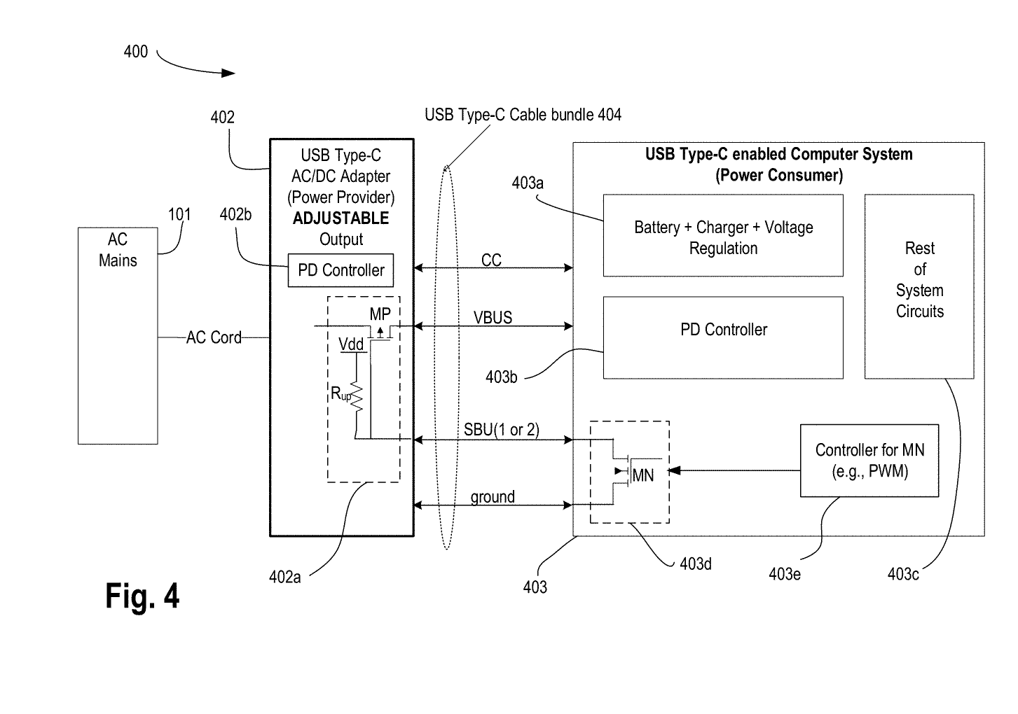

FIG. 4 illustrates a USB power delivery system 400 using an adjustable power source, in accordance with some embodiments of the disclosure. It is pointed out that those elements of FIG. 4 having the same reference numbers (or names) as the elements of any other figure can operate or function in any manner similar to that described, but are not limited to such. Compared to FIG. 1, here, the power supply provider is capable of dynamically providing an adjustable voltage or current, in accordance with some embodiments. This provider is referred to as Provider 402.

In some embodiments, Provider 402 is capable of receiving a power supply request via one or both of the SBU pins (SBU1 301 and SBU2 302) at any time and can service that request while using the same interface (i.e., the same USB Type-C Cable bundle 404). The USB Type-C specification defines two SBU pins that are uncommitted and are open or weakly tied to ground. Various embodiments, take advantage of this definition. In some embodiments, the unused SBU connection that is present in the full featured USB Type-C to USB Type-C cables is used to carry additional control to do fine grain control of the Power Adapter's output voltage on VBUS.

In some embodiments, Provider 402 includes hardware 402a to use SBU pins (1 and/or 2) to receive an indication that an adjusted power supply can be provided to Power Consumer 403. In some embodiments, Power Provider 402 (or power adapter) ties one of these pins to a voltage through an impedance and uses that pin to control its output voltage on VBUS. In some embodiments, Provider 402 includes PD Controller 402b which is used to control various functions of Provider 402 including the voltage level of VBUS. In some embodiments, when the SBU pin(s) (1 and/or 2) is not asserted, for example, when connected to a legacy power Consumer 103, the power adapter 402 simply outputs the voltage negotiated by USB PD Controller 402a/b. In some embodiments, when the SBU (1 and/or 2) pin is asserted, the power adapter's output voltage is reduced according to voltage/current modulation on the SBU pin.

In some embodiments, hardware 402a includes a pull-up resistor Rᵤₚ coupled to the SBU pins (1 and/or 2) and internal power supply Vdd. In some embodiments, when a Power Consumer detects that the SBU pin (1 and/or 2) is not an open (or high impedance) pin and instead is pulled-up to a supply level, then the Power Consumer knows that the VBUS is adjustable by using SBU (1 and/or 2). The VBUS value is negotiated using USB PD Controller 402a/b, in accordance with some embodiments. The various embodiments allow USB Provider 402 to provide adjustable power supply on VBUS when desired by USB Consumer 403, while maintaining the capability to provide fixed power supply on VBUS when USB Provider 402 is connected to a legacy Consumer.

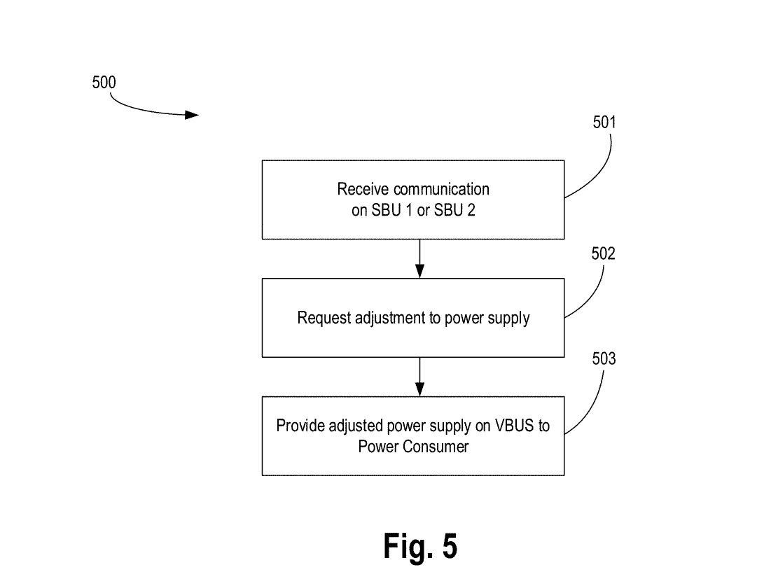

The pull-up resistor Rᵤₚ serves two functions—first to signal presence of the ability of a power adaptor to provide adjustable supply and second to provide the place for the power consumer to control the output voltage. In some embodiments, hardware 402a includes p-type transistor MP which represents the element that actually controls the power adapter's output voltage (e.g., instantaneous output voltage) on VBUS. In some embodiments, the function of p-type transistor MP is implemented in a voltage regulator (VR) control circuit of Power Adaptor 402. In some embodiments, Provider 402 includes part or all of blocks of FIG. 5 to execute the process of providing a new voltage and/or current.

Referring back to FIG. 4, here, Consumer 403 is different from Consumer 103 in that Consumer 403 is capable of requesting a new power voltage and/or current using the SBU (1 and/or 2) pin(s). In some embodiments, a consumer uses a PD Controller to negotiate a baseline voltage and current over the CC lines. In some embodiments, if a Consumer does not have a PD Controller, then the negotiated voltage is just a fixed output on VBUS from Provider 402. In some embodiments, Consumer 403 adjusts the voltage (not current) to an instantaneous voltage less than or equal to the negotiated voltage.

In some embodiments, Consumer 403, like Consumer 103, may be any consumer device (e.g., phone, laptop, printer, etc.) that uses the power supply provided by VBUS to operate and uses the USB Type-C interface. In some embodiments, Consumer 403 may include a regulation module or logic 403a such as a battery, charger, and/or voltage regulator (e.g., DC-DC switching regulator). Regulation module or logic 403a is a hardware block that receives power supply from VBUS and uses that power supply to provide regulated power supply to other blocks in Consumer 403.

In some embodiments, Consumer 403 also includes PD Controller 403b. In some embodiments, PD Controller 403b may be implemented in hardware or software and is responsible for communicating with Provider 402. The rest of the system circuits of Consumer 403 are lumped here in module 403c. In some embodiments, PD Controller 403b includes part or all of blocks of FIG. 5 to execute the process of requesting and receiving a new power supply.

In some embodiments, Power Consumer 403 includes hardware 403d which can pull-down the voltage on SBU (1 and/or 2) pins and/or adjust the voltage/current on the SBU (1 and/or 2) pins. In some embodiments, hardware 403d comprises an n-type transistor MN with a drain terminal coupled to one of the SBU pins and a source terminal coupled to ground. In some embodiments, hardware 403d represents the element that Power Consumer 403 uses to signal Power Provider 402 how much voltage to supply on VBUS. In some embodiments, block 403a may have intimate knowledge of the power consumer's battery's charge level, the amount of power the system is consuming, etc. In some embodiments, Power Consumer 403 includes Controller 403e to control hardware 403b. In some embodiments, 403a communicates with Controller 403e to manage turn on/off of hardware 403d (e.g., transistor MN). In some embodiments, hardware 403d uses that information to compute what voltage it needs and drive the transistor MN to actually control Power Provider 402 to deliver it that voltage.

In some embodiments, when Power Consumer 403 detects the voltage on the SBU pin (e.g., 1 and/or 2 pins), it knows that the output voltage on VBUS from Power Adapter 402 can be adjusted (e.g., reduced) by asserting and/or modulating the voltage/current on the SBU pin. In some embodiments, when Power Consumer 403 does not see a voltage on the SBU pin (e.g., when the SBU pin is open or in high impedance state), it knows the power adapter does not support this capability (e.g., the power adaptor is a traditional adaptor such as Power Adaptor 102).

In some embodiments, Power Consumer 403 may assert the SBU pin to change the output voltage on VBUS from Power Adapter 402 in several ways. For example, Controller 403e of Power Consumer 403 may provide a PWM (Pulse Width Modulated) signal to transistor MN which causes the SBU pin to be periodically pulled low for short intervals. In some embodiments, the duty cycle of the PWM signal can be used to instruct Power Provider 402 to adjust the voltage on VBUS. For example, when the larger amount of time the SBU pin is pulled low, the lower the output voltage on the VBUS is provided by Power Provider 402. In another example, Power Consumer 403 may reduce the voltage on the SBU pin that in turn lowers the output voltage on the VBUS of Power Provider 402. In another example, Power Consumer 403 may draw current from the SBU pin that in turn lowers the output voltage on the VBUS by Power Provider 402. In other embodiments, other mechanisms can be used to inform Power Provider 402 to adjust the output voltage on VBUS using SBU pin(s).

FIG. 5 illustrates flowchart 500 of a method to provide adjusted power supply, in accordance with some embodiments of the disclosure. At block 501, Power Provider 402 receives communication on one or both of SBU pins. For example, the SBU pin(s) are pulled down periodically by a PWM signal provided to transistor MN of Power Consumer 403. The activity of pulling down of the SBU pin(s) is akin to received communication at the Power Provider 402, in accordance with some embodiments. At block 422, Power Provider 402 requests one or more logic units (e.g., VR of Power Provider 402) to adjust the power supply on VBUS. At block 503, Power Provider 402 provides the adjusted power supply (e.g., lower power supply) on the VBUS to Power Consumer 403.

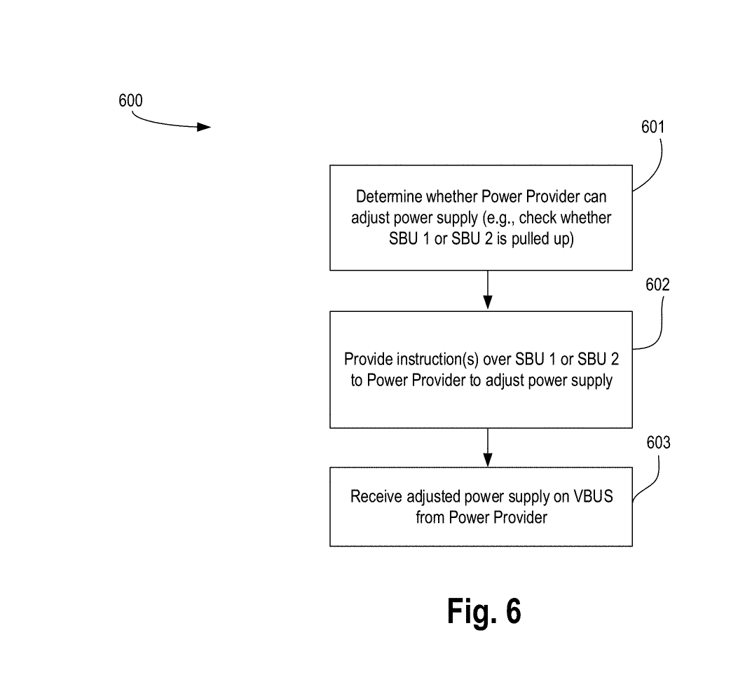

FIG. 6 illustrates flowchart 600 of a method to request power supply, in accordance with some embodiments of the disclosure. At block 601, Power Consumer 403 determines whether Power Provider 402 can adjust power supply on the VBUS. For example, Power Consumer 403 senses the state of the SBU pin(s) to determine whether they are open or pulled-up. While various embodiments are described with reference to the state of SBU pins, in other embodiments other pins in the Type-C eco-system may be repurposed. For example, the D+/D− pin pairs may be repurposed to replace the SBUs in accordance with some embodiments.

At block 602, Power Consumer 403 provides instructions over the SBU pin(s) to Power Provider 402 to adjust a power supply on the VBUS. The instructions can be in a one or more forms. For example, a duty cycle of a PWM signal can be used to instruct Power Provider 402 to adjust the voltage on VBUS. In another example, when larger amount of time the SBU pin is pulled low, the lower the output voltage on the VBUS is provided by Power Provider 402. In another example, Power Consumer 403 may reduce the voltage on the SBU pin that in turn lowers the output voltage on the VBUS of Power Provider 402. In yet another example, Power Consumer 403 may draw current from the SBU pin that in turn lowers the output voltage on the VBUS by Power Provider 402. In other embodiments, other mechanisms can be used to instruct Power Provider 402 to adjust the output voltage on VBUS using SBU pin(s). In some embodiments, the instructions are in the form of a signal embedded in a shared transport. For example, the instruction are in the form of a signal embedded on the SBU or another pin. At block 603, Power Consumer 403 receives the adjusted power supply on the VBUS from Power Provider 402.

Although the blocks in the flowchart with reference to FIGS. 5-6 are shown in a particular order, the order of the actions can be modified. Thus, the illustrated embodiments can be performed in a different order, and some actions/blocks may be performed in parallel. Some of the blocks and/or operations listed in FIGS. 5-6 are optional in accordance with certain embodiments. The numbering of the blocks presented is for the sake of clarity and is not intended to prescribe an order of operations in which the various blocks must occur. Additionally, operations from the various flows may be utilized in a variety of combinations.

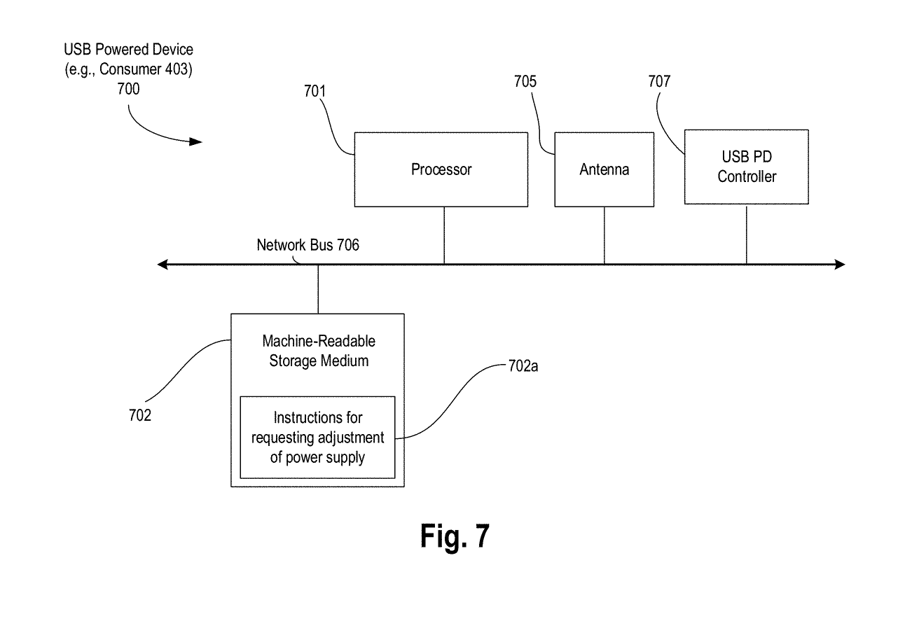

FIG. 7 illustrates a USB powered device 700 (e.g., at least a part of Consumer 403) with a machine readable storage media having instructions that when executed cause a machine (e.g., processor) to perform an operation for dynamically requesting adjustment in power supply. It is pointed out that those elements of FIG. 7 having the same reference numbers (or names) as the elements of any other figure can operate or function in any manner similar to that described, but are not limited to such.

In some embodiments, USB powered device 700 (e.g., Consumer 403) comprises a low power Processor 701 (e.g., a Digital Signal Processor (DSP), an Application Specific Integrated Circuit (ASIC), a general purpose Central Processing Unit (CPU), or a low power logic implementing a simple finite state machine to perform the method of flowchart 600 associated with Consumer 403, etc.), Machine-Readable Storage Medium 702 (also referred to as tangible machine readable medium), Antenna 705, Network Bus 706, and USB PD Controller 707 (e.g., PD Controller 403b).

In some embodiments, the various logic blocks of Consumer 403 are coupled together via Network Bus 706. Any suitable protocol may be used to implement Network Bus 706. In some embodiments, Machine-Readable Storage Medium 702 includes Instructions 702a (also referred to as the program software code/instructions) for requesting and accepting a new power supply (e.g., new voltage and/or current) as described with reference to various embodiments and flowchart. Here, Instructions 702a are the instructions performed by Consumer 403 in flowchart 600 as described with reference to FIG. 6.

Referring back to FIG. 7, program software code/instructions 702a, associated with Consumer 403 part of flowchart 600, as described with reference to FIG. 6, and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with Consumer 403 end of flowchart 600, as described with reference to FIG. 6, are executed by Consumer 403.

Referring back to FIG. 7, in some embodiments, the program software code/instructions 702a associated with flowchart 600 are stored in a computer executable storage medium 702 and executed by Processor 701. Here, computer executable storage medium 702 is a tangible machine readable medium that can be used to store program software code/instructions and data that, when executed by a computing device, causes one or more processors (e.g., Processor 701) to perform a method(s) as may be recited in one or more accompanying claims directed to the disclosed subject matter.

The tangible machine readable medium 702 may include storage of the executable software program code/instructions 702a and data in various tangible locations, including for example ROM, volatile RAM, non-volatile memory and/or cache and/or other tangible memory as referenced in the present application. Portions of this program software code/instructions 702a and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions 702a (associated with Consumer 403 part of flowchart 600 as described with reference to FIG. 6 and other embodiments) and data can be obtained in their entirety prior to the execution of a respective software program or application by the computing device. Alternatively, portions of the software program code/instructions 702a and data can be obtained dynamically, e.g., just in time, when needed for execution. Alternatively, some combination of these ways of obtaining the software program code/instructions 702a and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media 702 include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), USB thumb drives, etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium 702 includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

Here, Antenna 705 can be any antenna. For example, in some embodiments, Antenna 705 may comprise one or more directional or omnidirectional antennas, including monopole antennas, dipole antennas, loop antennas, patch antennas, microstrip antennas, coplanar wave antennas, or other types of antennas suitable for transmission of RF (Radio Frequency) signals. In some multiple-input-multiple-output (MIMO) embodiments, Antenna(s) 705 are separated to take advantage of spatial diversity.

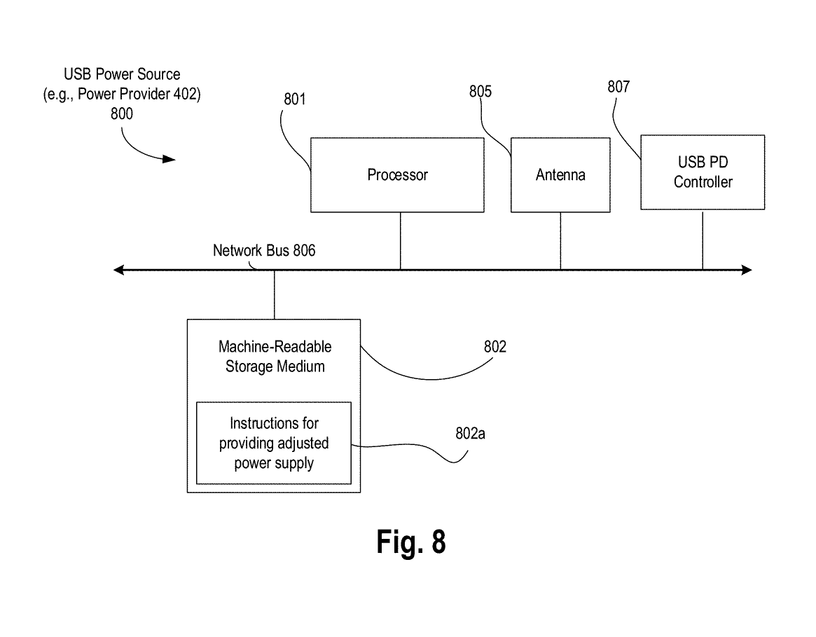

FIG. 8 illustrates an adjustable USB power source 800 (e.g., at least part of Provider 402) with a machine readable storage media having instructions that when executed cause a machine (e.g., processor) to perform an operation for dynamically providing adjusted power supply upon request. It is pointed out that those elements of FIG. 8 having the same reference numbers (or names) as the elements of any other figure can operate or function in any manner similar to that described, but are not limited to such.

In some embodiments, adjustable USB power source 800 (e.g., part of Provider 402) comprises a low power Processor 801 (e.g., a DSP, an ASIC, a general purpose CPU, or a low power logic implementing a simple finite state machine to perform the method of flowchart 500 associated with Provider 402, etc.), Machine-Readable Storage Medium 802 (also referred to as tangible machine readable medium), Antenna 805, Network Bus 806, and USB PD Controller 807.

In some embodiments, the various logic blocks of Provider 402 are coupled together via Network Bus 806. Any suitable protocol may be used to implement Network Bus 806. In some embodiments, Machine-Readable Storage Medium 802 includes Instructions 802a (also referred to as the program software code/instructions) for requesting and accepting a new power supply (e.g., new voltage and/or current) as described with reference to various embodiments and flowchart. Here, Instructions 802a are the instructions performed by Provider 402 in flowchart 500 as described with reference to FIG. 5.

Program software code/instructions 502a, associated with Provider 402 of flowchart 500, as described with reference to FIG. 5, and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with Provider 402 of flowchart 500, as described with reference to FIG. 5, are executed by Processor or logic (e.g., finite state machine) 801 of Provider 402.

In some embodiments, the program software code/instructions 802a associated with flowchart 500 are stored in a computer executable storage medium 802 and executed by Processor 801. Here, computer executable storage medium 802 is a tangible machine readable medium that can be used to store program software code/instructions and data that, when executed by a computing device, causes one or more processors (e.g., Processor 801) to perform a method(s) as may be recited in one or more accompanying claims directed to the disclosed subject matter.

The tangible machine readable medium 802 may include storage of the executable software program code/instructions 802a and data in various tangible locations, including for example ROM, volatile RAM, non-volatile memory and/or cache and/or other tangible memory as referenced in the present application. Portions of this program software code/instructions 802a and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in the same communication session.

The software program code/instructions 802a (associated with Provider 402 of flowchart 500 as described with reference to FIG. 5 and other embodiments) and data can be obtained in their entirety prior to the execution of a respective software program or application by the computing device. Alternatively, portions of the software program code/instructions 802a and data can be obtained dynamically, e.g., just in time, when needed for execution. Alternatively, some combination of these ways of obtaining the software program code/instructions 802a and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media 802 include but are not limited to recordable and non-recordable type media such as volatile and non-volatile memory devices, ROM, RAM, flash memory devices, floppy and other removable disks, magnetic storage media, optical storage media (e.g., CD ROMS, DVDs, USB thumb drives, etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium 802 includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

Here, Antenna 805 can be any antenna. For example, in some embodiments, Antenna 805 may comprise one or more directional or omnidirectional antennas, including monopole antennas, dipole antennas, loop antennas, patch antennas, microstrip antennas, coplanar wave antennas, or other types of antennas suitable for transmission of RF signals. In some MIMO embodiments, Antenna(s) 805 are separated to take advantage of spatial diversity.

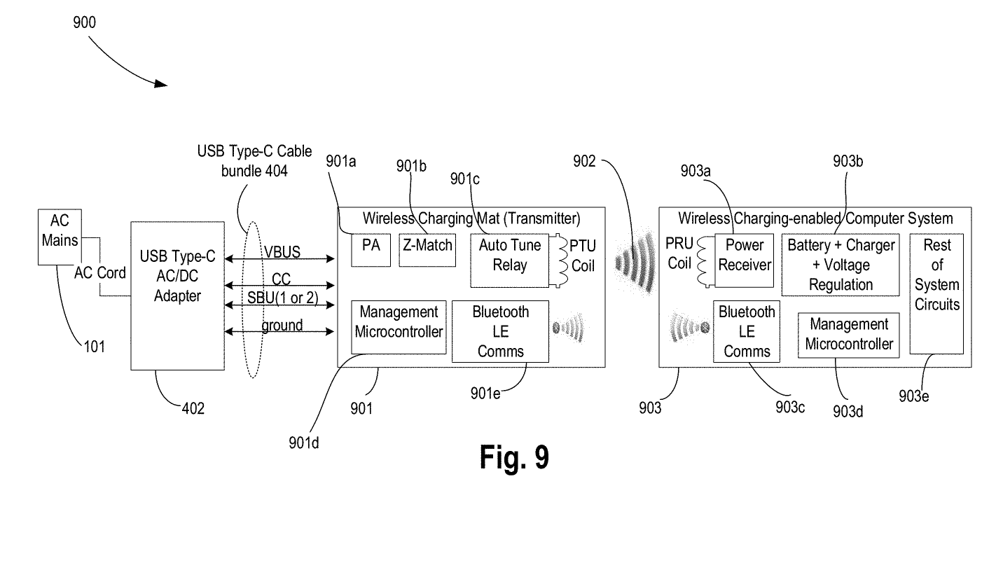

FIG. 9 illustrates a USB power delivery system 900 using an adjustable power source in a wireless charging environment, in accordance with some embodiments of the disclosure. It is pointed out that those elements of FIG. 9 having the same reference numbers (or names) as the elements of any other figure can operate or function in any manner similar to that described, but are not limited to such.

In some embodiments, USB power delivery system 900 comprises AC Main 101, Provider 402, Wireless Charging Mat Transmitter (Tx) 901, and Wireless Charging-enabled Computer System 903. In some embodiments, Wireless Charging Mat Transmitter (Tx) 901 comprises Power Amplifier (PA) 901a, Impedance Matching stage 901b, Auto Tune Relay 901c, Management Microcontroller 901d (e.g., system 500), Bluetooth Low Energy (LE) compliant Communication module 901e, and Power Transmitter Unit (PTU) Coil. In some embodiments, Wireless Charging Mat Tx 901 includes hardware 403d and/or Controller 403e as described with reference to Power Consumer 403 of FIG. 4A. Referring back to FIG. 6, the Auto Tune Relay 901c together with the PTU Coil sends power 902 wirelessly to Wireless Charging-enabled Computer System 903, in accordance with some embodiments.

In some embodiments, radio frequency Power Amplifier (PA 901a) is a type of electronic amplifier used to convert a low-power signal into a larger signal of significant power, typically for driving the antenna of a transmitter. In some embodiments, Impedance Matching (Z-Match 901b) provides an output impedance of a signal source to match with the physical impedance characteristics of an antenna in order to maximize the power transfer and/or minimize the signal reflection. In some embodiments, Auto Tune Relay 901c is a switching circuit that automatically adjusts the frequency of a radio transmission. In some embodiments, the PTU Coil is a wire winding, typically circular, oval, or rectangular, which acts as the antenna for the transmission of wireless power. In some embodiments, a Management Microcontroller 901d is a general-purpose microprocessor embedded with firmware which is able to execute code (e.g., code to manage the Power Delivery algorithms and communications for a device). In some embodiments, Bluetooth LE Communications module 901e is a kind of radio by which two devices may exchange data messages (e.g., Power Delivery management messages).

In some embodiments, Wireless Charging-enabled Computer System 903 comprises: Power Receiver Unit (PRU) Coil, Power Receiver 903a, Voltage Regulation module 903b (e.g., Battery, Charger, low-dropout regulator, etc.), Bluetooth LE Communication module 903c, Management Microcontroller 903d, and Rest of System Circuits 903e. In some embodiments, the PRU Coil receives the power 902 transmitted by PTU Coil of Tx 901c.

In some embodiments, the PRU Coil is a wire winding, typically circular, oval, or rectangular, which acts as the antenna for the reception of wireless power. In some embodiments, a Battery (e.g., part of 903b) is provided which is a reservoir for the storage of electrical power until later use is required. In some embodiments, a Charger (part of 903b) is provided which is an electronic circuit that uses methods for the optimal insertion and storage of electrical charge into the Battery. In some embodiments, a voltage regulator (part of 903b) is provided which is provides voltage regulation to constrain the delivery of a voltage to a load circuit to within a narrow range (for example, ±5%) even over a wide range of load conditions (for example, the current demands of the load circuit rise and fall dynamically). The input of the voltage regulator may be close to the target output voltage (e.g., input=+5V±20% and output=+5V±5%) or it may be a very different voltage (e.g., “buck regulator”: input=+20V±20% and output=+5V±5%, or “boost regulator”: input=+3.3V±10% and output=+9V±5%).

In some embodiments, Management Microcontroller 903d is provided which is a general-purpose microprocessor embedded with firmware which is able to execute code (e.g., code to manage the Power Delivery algorithms and communications for a device). In some embodiments, Bluetooth LE Communications module 903c is provided which is an example of one kind of radio by which two devices may exchange data messages (e.g., Power Delivery management messages).

In some embodiments, power efficiency information collected by/from the PRU is passed over Bluetooth LE Comm. 903c from Management Microcontroller 903d to Management Microcontroller 901d of Wireless Charging Mat 901. Here, power efficiency generally refers to the power provided by Provider 402 over VBUS compared to the power 902 transmitted by Wireless Charging Mat 901.

For example, in a fully efficient power system, the power provided by Provider 402 is equal to the power 902 transmitted by Wireless Charging Mat 901. When power 902 is less than the power on VBUS, then power efficiency is low. One reason for lower power efficiency is when there is a physical proximity offset between PTU Coil and PRU Coil. Power efficiency can improve (e.g., increase) when the offset between the PTU Coil and PRU Coil is close to zero (e.g., when the PTU Coil of Wireless Charging Mat 901 is exactly below or above the PRU Coil of Wireless Charging enabled Computer System 903).

In some embodiments, in response to this power efficiency information, Management Microcontroller 903d sends a request for a more optimal power level to Management Microcontroller 901d over Bluetooth LE, whereupon Management Microcontroller 901d instructions hardware 403d to modulate voltage or current on SBU pin to communicate with Power Provider 402 to adjust supply on VBUS. In some embodiments, Provider 402 adjusts its voltage and/or current output and supplies it to Wireless Charging Mat 901 over VBUS to better meet the needs determined by the analysis at the PRU. As such, power efficiency is brought closer to or at one.

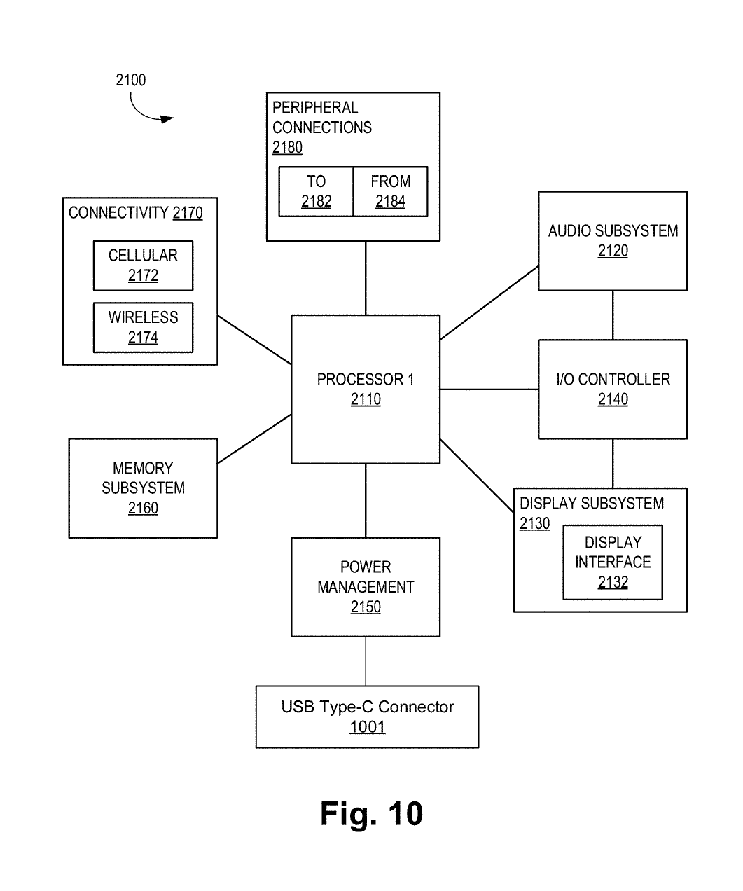

FIG. 10 illustrates a USB compliant smart device 2100 (e.g., Provider, Consumer, or Charging Mat) or a computer system or a SoC (System-on-Chip) having logic to dynamically request and receive adjustable power supply from an adjustable USB power source, or logic to dynamically receive a request for new power supply and to dynamically provide the new power supply via USB Type-C connector 1001 (e.g., connector to Power Provider 402 or Power Consumer 403), according to some embodiments. It is pointed out that those elements of FIG. 10 having the same reference numbers (or names) as the elements of any other figure can operate or function in any manner similar to that described, but are not limited to such.

FIG. 10 illustrates a block diagram of an embodiment of a mobile device in which flat surface interface connectors could be used. In some embodiments, computing device 2100 represents a mobile computing device, such as a computing tablet, a mobile phone or smart-phone, a wireless-enabled e-reader, or other wireless mobile device. It will be understood that certain components are shown generally, and not all components of such a device are shown in computing device 2100.

In some embodiments, computing device 2100 includes a first processor 2110 having interconnects and transistors with engineered corner regions for improving carrier flow, according to some embodiments discussed. Other blocks of the computing device 2100 may also include interconnects and transistors with engineered corner regions for improving carrier flow of some embodiments. The various embodiments of the present disclosure may also comprise a network interface within 2170 such as a wireless interface so that a system embodiment may be incorporated into a wireless device, for example, cell phone or personal digital assistant.

In one embodiment, processor 2110 (and/or processor 2190) can include one or more physical devices, such as microprocessors, application processors, microcontrollers, programmable logic devices, or other processing means. The processing operations performed by processor 2110 include the execution of an operating platform or operating system on which applications and/or device functions are executed. The processing operations include operations related to I/O (input/output) with a human user or with other devices, operations related to power management, and/or operations related to connecting the computing device 2100 to another device. The processing operations may also include operations related to audio I/O and/or display M.

In one embodiment, computing device 2100 includes audio subsystem 2120, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into computing device 2100, or connected to the computing device 2100. In one embodiment, a user interacts with the computing device 2100 by providing audio commands that are received and processed by processor 2110.

Display subsystem 2130 represents hardware (e.g., display devices) and software (e.g., drivers) components that provide a visual and/or tactile display for a user to interact with the computing device 2100. Display subsystem 2130 includes display interface 2132, which includes the particular screen or hardware device used to provide a display to a user. In one embodiment, display interface 2132 includes logic separate from processor 2110 to perform at least some processing related to the display. In one embodiment, display subsystem 2130 includes a touch screen (or touch pad) device that provides both output and input to a user.

I/O controller 2140 represents hardware devices and software components related to interaction with a user. I/O controller 2140 is operable to manage hardware that is part of audio subsystem 2120 and/or display subsystem 2130. Additionally, I/O controller 2140 illustrates a connection point for additional devices that connect to computing device 2100 through which a user might interact with the system. For example, devices that can be attached to the computing device 2100 might include microphone devices, speaker or stereo systems, video systems or other display devices, keyboard or keypad devices, or other I/O devices for use with specific applications such as card readers or other devices.

As mentioned above, I/O controller 2140 can interact with audio subsystem 2120 and/or display subsystem 2130. For example, input through a microphone or other audio device can provide input or commands for one or more applications or functions of the computing device 2100. Additionally, audio output can be provided instead of, or in addition to display output. In another example, if display subsystem 2130 includes a touch screen, the display device also acts as an input device, which can be at least partially managed by I/O controller 2140. There can also be additional buttons or switches on the computing device 2100 to provide I/O functions managed by I/O controller 2140.

In one embodiment, I/O controller 2140 manages devices such as accelerometers, cameras, light sensors or other environmental sensors, or other hardware that can be included in the computing device 2100. The input can be part of direct user interaction, as well as providing environmental input to the system to influence its operations (such as filtering for noise, adjusting displays for brightness detection, applying a flash for a camera, or other features).

In one embodiment, computing device 2100 includes power management 2150 that manages battery power usage, charging of the battery, and features related to power saving operation. Memory subsystem 2160 includes memory devices for storing information in computing device 2100. Memory can include nonvolatile (state does not change if power to the memory device is interrupted) and/or volatile (state is indeterminate if power to the memory device is interrupted) memory devices. Memory subsystem 2160 can store application data, user data, music, photos, documents, or other data, as well as system data (whether long-term or temporary) related to the execution of the applications and functions of the computing device 2100.

Elements of embodiments are also provided as a machine-readable medium (e.g., memory 2160) for storing the computer-executable instructions (e.g., instructions to implement any other processes discussed herein). The machine-readable medium (e.g., memory 2160) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

Connectivity 2170 includes hardware devices (e.g., wireless and/or wired connectors and communication hardware) and software components (e.g., drivers, protocol stacks) to enable the computing device 2100 to communicate with external devices. The computing device 2100 could be separate devices, such as other computing devices, wireless access points or base stations, as well as peripherals such as headsets, printers, or other devices.

Connectivity 2170 can include multiple different types of connectivity. To generalize, the computing device 2100 is illustrated with cellular connectivity 2172 and wireless connectivity 2174. Cellular connectivity 2172 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, or other cellular service standards. Wireless connectivity (or wireless interface) 2174 refers to wireless connectivity that is not cellular, and can include personal area networks (such as Bluetooth, Near Field, etc.), local area networks (such as Wi-Fi), and/or wide area networks (such as WiMax), or other wireless communication.

Peripheral connections 2180 include hardware interfaces and connectors, as well as software components (e.g., drivers, protocol stacks) to make peripheral connections. It will be understood that the computing device 2100 could both be a peripheral device (“to” 2182) to other computing devices, as well as have peripheral devices (“from” 2184) connected to it. The computing device 2100 commonly has a “docking” connector to connect to other computing devices for purposes such as managing (e.g., downloading and/or uploading, changing, synchronizing) content on computing device 2100. Additionally, a docking connector can allow computing device 2100 to connect to certain peripherals that allow the computing device 2100 to control content output, for example, to audiovisual or other systems.

In addition to a proprietary docking connector or other proprietary connection hardware, the computing device 2100 can make peripheral connections 1680 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive

While the disclosure has been described in conjunction with specific embodiments thereof, many alternatives, modifications and variations of such embodiments will be apparent to those of ordinary skill in the art in light of the foregoing description. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

For example, in some embodiments, apparatus is provided which comprises: a pull-up resistive device to pull-up a sideband unit (SBU) pin; and logic to adjust a voltage level on a bus voltage (VBUS) pin according to a voltage or current condition on the SBU pin. In some embodiments, the SBU pin is part of a Universal Serial Bus (USB) Type-C connector. In some embodiments, the pull-up resistive device is a resistor having a first terminal coupled to an interconnect which is coupled to the SBU pin, and a second terminal coupled an internal power supply node. In some embodiments, the logic is a Power Delivery (PD) Controller which is complaint with a Universal Serial Bus (USB) Type-C Specification. In some embodiments, the apparatus comprises a switch coupled to the VBUS pin and controllable by the SBU pin. In some embodiments, the SBU pin is coupled to a consumer device which is operable to modulate voltage or current on the SBU pin.

In another example, an apparatus is provided which comprises logic to modulate a voltage or current; circuit to receive the modulated voltage or current, wherein the circuit is coupled to a sideband unit (SBU) pin and is to modify a voltage or current condition of the SBU pin; and a bus voltage (VBUS) pin to receive a power supply according to the voltage or current condition of the SBU pin. In some embodiments, the SBU pin is part of a Universal Serial Bus Type-C connector. In some embodiments, the logic is to modulate the voltage and/or current using a pulse width modulator. In some embodiments, the SBU pin is electrically coupled to a power provider which comprises: a pull-up resistive device to pull-up the SBU pin; and logic to adjust a voltage level on the VBUS pin according to the voltage or current condition on the SBU pin. In some embodiments, the pull-up resistive device is a resistor having a first terminal coupled to an interconnect which is coupled to the SBU pin, and a second terminal coupled an internal power supply node. In some embodiments, the logic of the power provider is a Power Delivery (PD) Controller which is complaint with a Universal Serial Bus (USB) Type-C Specification. In some embodiments, the power provider comprises a switch coupled to the VBUS pin and controllable by the SBU pin.

In another example, a system is provided which comprises a power provider having a first sideband unit (SBU) pin to be pulled high, wherein the power provider is to be coupled to a power consumer having a second SBU pin, wherein the power consumer is operable to modulate voltage or current on the second SBU pin, and wherein the power provider is to be coupled to a power consumer via a Universal Serial Bus (USB) Type-C cable such that the first and second SBU pins are electrically connected. In some embodiments, the power provider includes logic to adjust a voltage level on a bus voltage (VBUS) pin according to a voltage or current condition on the first SBU pin. In some embodiments, the power provider comprises: a pull-up resistive device to pull-up the first SBU pin; and logic to adjust a voltage level on the VBUS pin according to the voltage or current condition on the first SBU pin.

In some embodiments, the pull-up resistive device is a resistor having a first terminal coupled to an interconnect which is coupled to the first SBU pin, and a second terminal coupled an internal power supply node. In some embodiments, the logic of the power provider is a Power Delivery (PD) Controller which is complaint with a Universal Serial Bus (USB) Type-C Specification. In some embodiments, the power provider comprises a switch coupled to the VBUS pin and controllable by the first SBU pin. In some embodiments, the power consumer comprises: logic to modulate a voltage or current; circuit to receive the modulated voltage or current, wherein the circuit is coupled to the second SBU pin and is to modify a voltage or current condition of the second SBU pin; and a bus voltage (VBUS) pin to receive a power supply according to the voltage or current condition of the second SBU pin.

In another example, a method is provided which comprises: receiving an instruction on a sideband unit (SBU) pin; requesting adjustment to a power supply to be provided on a bus voltage (VBUS) pin; and providing the adjusted power supply on the VBUS pin to a power consumer. In some embodiments, the instruction is a voltage or current condition on the SBU pin. In some embodiments, the method comprises pulling up a voltage on the SBU pin. In some embodiments, the method turning on a switch to provide adjusted power supply to the VBUS pin.

In another example, an apparatus is provided which comprises: means for receiving an instruction on a sideband unit (SBU) pin; means for requesting adjustment to a power supply to be provided on a bus voltage (VBUS) pin; and means for providing the adjusted power supply on the VBUS pin to a power consumer. In some embodiments, the instruction is a voltage or current condition on the SBU pin. In some embodiments, the apparatus comprises means for pulling up a voltage on the SBU pin. In some embodiments, the apparatus comprises means for turning on a switch to provide adjusted power supply to the VBUS pin.

In another example, a method is provided which comprises: receiving an instruction via a signal embedded in a shared transport; requesting adjustment to a power supply to be provided on a bus voltage (VBUS) pin; and providing the adjusted power supply on the VBUS pin to a power consumer. In some embodiments, the instruction is a voltage or current condition on the shared transport. In some embodiments, the shared transport is a sideband unit (SBU) pin. In some embodiments, the shared transport is a data pin. In some embodiments, the method comprises pulling up a voltage on the SBU pin. In some embodiments, the method comprises turning on a switch to provide adjusted power supply to VBUS.

In another example, an apparatus is provided which comprises: means for receiving an instruction via a signal embedded in a shared transport; means for requesting adjustment to a power supply to be provided on a bus voltage (VBUS) pin; and means for providing the adjusted power supply on the VBUS pin to a power consumer. In some embodiments, the instruction is a voltage or current condition on the shared transport. In some embodiments, the shared transport is a SBU pin. In some embodiments, the shared transport is a data pin. In some embodiments, the apparatus comprises means for pulling up a voltage on the SBU pin. In some embodiments, the apparatus comprises means for turning on a switch to provide adjusted power supply to VBUS.

In another example, an apparatus is provided which comprises: a pull-up resistive device to pull-up a dedicated pin; and logic to adjust a voltage level on a bus voltage (VBUS) pin according to a voltage or current condition on the dedicated pin. In some embodiments, the dedicated pin is part of a Universal Serial Bus (USB) Type-C connector. In some embodiments, the pull-up resistive device is a resistor having a first terminal coupled to an interconnect which is coupled to the dedicated pin, and a second terminal coupled an internal power supply node. In some embodiments, the logic is a Power Delivery (PD) Controller which is complaint with a Universal Serial Bus (USB) Type-C Specification. In so embodiments, the apparatus comprises a switch coupled to the VBUS pin and controllable by the dedicated pin. In some embodiments, the dedicated pin is coupled to a consumer device which is operable to modulate voltage or current on the dedicated pin. In some embodiments, the dedicated pin is a Sideband Unit (SBU) pin. In some embodiments, the dedicated pin is a data pin.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

What is claimed is:

1. An apparatus comprising:
a pull-up resistive device to pull-up a sideband unit (SBU) pin; and
logic to adjust a voltage level on a bus voltage (VBUS) pin according to a voltage or current condition on the SBU pin.

2. The apparatus of claim 1, wherein the SBU pin is part of a Universal Serial Bus (USB) Type-C connector.

3. The apparatus of claim 1, wherein the pull-up resistive device is a resistor having a first terminal coupled to an interconnect which is coupled to the SBU pin, and a second terminal coupled an internal power supply node.

4. The apparatus of claim 1, wherein the logic is a Power Delivery (PD) Controller which is complaint with a Universal Serial Bus (USB) Type-C Specification.

5. The apparatus of claim 1 comprises a switch coupled to the VBUS pin and controllable by the SBU pin.

6. The apparatus of claim 1, wherein the SBU pin is coupled to a consumer device which is operable to modulate voltage or current on the SBU pin.

7. An apparatus comprising:
logic to modulate a voltage or current;
circuit to receive the modulated voltage or current, wherein the circuit is coupled to a sideband unit (SBU) pin and is to modify a voltage or current condition of the SBU pin; and
a bus voltage (VBUS) pin to receive a power supply according to the voltage or current condition of the SBU pin.

8. The apparatus of claim 7, wherein the SBU pin is part of a Universal Serial Bus Type-C connector.

9. The apparatus of claim 7, wherein the logic is to modulate the voltage and/or current using a pulse width modulator.

10. The apparatus of claim 7, wherein the SBU pin is electrically coupled to a power provider which comprises:
a pull-up resistive device to pull-up the SBU pin; and
logic to adjust a voltage level on the VBUS pin according to the voltage or current condition on the SBU pin.

11. The apparatus of claim 10, wherein the pull-up resistive device is a resistor having a first terminal coupled to an interconnect which is coupled to the SBU pin, and a second terminal coupled an internal power supply node.

12. The apparatus of claim 10, wherein the logic of the power provider is a Power Delivery (PD) Controller which is complaint with a Universal Serial Bus (USB) Type-C Specification.

13. The apparatus of claim 10, wherein the power provider comprises a switch coupled to the VBUS pin and controllable by the SBU pin.

14. An apparatus comprising:
a pull-up resistive device to pull-up a dedicated pin; and
logic to adjust a voltage level on a bus voltage (VBUS) pin according to a voltage or current condition on the dedicated pin.

15. The apparatus of claim 14, wherein the dedicated pin is part of a Universal Serial Bus (USB) Type-C connector.

16. The apparatus of claim 14, wherein the pull-up resistive device is a resistor having a first terminal coupled to an interconnect which is coupled to the dedicated pin, and a second terminal coupled an internal power supply node.

17. The apparatus of claim 14, wherein the logic is a Power Delivery (PD) Controller which is complaint with a Universal Serial Bus (USB) Type-C Specification.

18. The apparatus of claim 14 comprises a switch coupled to the VBUS pin and controllable by the dedicated pin.

19. The apparatus of claim 14, wherein the dedicated pin is coupled to a consumer device which is operable to modulate voltage or current on the dedicated pin.

20. The apparatus of claim 14, wherein the dedicated pin is a Sideband Unit (SBU) pin.

21. The apparatus of claim 14, wherein the dedicated pin is a data pin.
